(19) United States
(12) Patent Application Publication
(10) Pub. No.: US 2023/0313091 A1
(43) Pub. Date: Oct. 5, 2023

(54) COCKTAIL SMOKING CHIMNEYS WITH INTEGRATED FANS AND METHODS FOR INFUSING SMOKE INTO COCKTAILS, BEVERAGES AND ALCOHOLIC DRINKS

(71) Applicant: Blake A. Oliver, Beacon, NY (US)

(72) Inventor: Blake A. Oliver, Beacon, NY (US)

(21) Appl. No.: 18/130,365

(22) Filed: Apr. 3, 2023

Related U.S. Application Data
(60) Provisional application No. 63/326,932, filed on Apr. 4, 2022.

(51) Int. Cl. C12G 3/07

(52) U.S. Cl. CPC C12G 3/07

(57) ABSTRACT

A cocktail smoking chimney for infusing smoke into a beverage includes a sealing base having a top major surface, a bottom major surface, and a smoke transfer opening located at the bottom major surface. The cocktail smoking chimney includes a chimney stack having an upper end, a lower end, and a central opening extending from the upper end to the lower end of the chimney stack. The central opening of the chimney stack is in fluid communication with the smoke transfer opening formed in the bottom major surface of the sealing base. A porous screen is disposed inside the central opening of the chimney stack, adjacent the upper end of the chimney stack that is configured for holding wood chips or wood powder that are burned for generating smoke. The cocktail smoking chimney includes a source of positive air pressure in communication with the central opening of the chimney stack for creating a vacuum within the central opening that draws the smoke from the screen and forces the smoke to flow toward the lower end of the chimney stack and toward the smoke transfer opening formed in the bottom major surface of the sealing base.

### CROSS-REFERENCE TO RELATED APPLICATIONS

The present patent application claims benefit of U.S. Provisional Application Ser. No. 63/326,932, filed on Apr. 4, 2022, the disclosure of which is hereby incorporated by reference herein. The present patent application is related to commonly owned U.S. patent application Ser. No. 17/158,179, filed on Jan. 26, 2021, and U.S. patent application Ser. No. 17/227,344, filed on Apr. 11, 2021, the disclosures of which are hereby incorporated by reference herein.

### BACKGROUND OF THE INVENTION

### Field of the Invention

The present patent application is generally related to systems and devices for generating smoke, and is more specifically related to system, devices and methods for infusing smoke into beverages such as cocktails, beverages and alcoholic drinks.

### Description of the Related Art

There have been a number of efforts directed to generating smoke and infusing smoke into food and beverages. For example, U.S. Pat. No. 6,481,344 to Green et al. discloses a smoke generating device for use in providing flavored smoke in a controlled manner. The smoke generating device includes a non-combustible, sealed, pressurized container. An organic matter disposed within the container is capable of producing a smoke without igniting. The container has at least one perforation, which enables the container to become pressurized so that smoke flows out of the container in a controlled direction and at a velocity that does not combust during heating of the container.

U.S. Pat. No. 6,705,213 to Thomas discloses a smoke generator having an air pump with a control valve to supply a continuous controllable air supply to a smoking fuel disposed on a grid in a fire box. Smoke is directed to a food processor from a smoke output within the fire box and above the grid. A chimney extends from the top of the fire box. The first box is filled with a fuel that is not in the air stream, so it does not burn. As the fuel on the grid is consumed, fuel from the chimney drops onto the grid, which provides a continuous feed of fresh fuel so that the smoke generator can, while unattended, generate a uniform controllable stream of smoke over a long period of time. A disposable fuel cartridge is provided for ease of use.

U.S. Pat. No. 6,971,305 to Thomas discloses an assembly for generating a continuous stream of smoke for food processing (e.g., barbecue cooking). The assembly includes a reusable cartridge holder for holding upright a disposable smoke generating cartridge. The cartridge includes an outer covering enclosing a chamber. The covering includes a perforated top, a non-perforated upper portion designed to not burn during the process, and a readily combustible lower portion. At the bottom of the chamber is a readily combustible tinder material that is easily set afire by the burning lower portion. The balance of the chamber is filled with wood pellets that smolder and emit desirable smoke when ignited by the tinder, the smoke passing upward through the perforated top. The convection currents produce a stream of smoke without the need for a fan. The pellets do not fall through the cartridge after the bottom portion burns away because they swell up and are held in place within the upper portion.

US 2020/0107565 to Swayne et al. disclose a device for injecting dry smoke into a food product. The device includes a smoke injector having an external wall with a plurality of apertures formed therein that communicate with a smoke-injector conduit. The smoke-injector conduit is in fluid communication with a smoke reservoir that houses dry smoking media therein. A fan directs dry smoke produced from the dry smoking media into the smoke-injector conduit so that the dry smoke is eluted through said plurality of apertures in order to introduce the dry smoke to an interior of a food product that has been impaled by the smoke injector.

US 2020/0221718 to Flood et al. disclose a smoke generation pod for use in a smoke generation system. The smoke generation pod includes an enclosure that has disposed therein a material such as wood that is heated or ignited by a heating element housed within the smoke generation pod, receiving energy from an induction coil. The smoke generation pod has an input vent for accepting air and an output vent for distributing smoke. The smoke is routed to an object such as a glass (with or without a liquid there within) for infusing the smoke into the liquid or onto the object. In some embodiments, the output vent has a filter. In some embodiments, some filters remove some or all of the carcinogens from the smoke that is emitted.

CN 202311122 discloses a low-temperature smoke generator. The smoke generator includes an outer barrel, an inner barrel and a base, whereby the shape of the base is matched with those of the outer barrel and the inner barrel. The inner barrel is arranged in the outer barrel. The outer barrel and the inner barrel are arranged on the base. The bottom of the outer barrel is open, and the top of the outer barrel is sealed. The top of the inner barrel is open, and the bottom of the inner barrel is sealed. An annular smoke and air space is formed among the outer barrel, the inner barrel and the base. A side wall of the outer barrel is equal to or higher than that of the inner barrel. The base is a concave or convex annular cylinder. The low-temperature smoke generator has a simple structure and a small overall volume, is convenient to detach and has a low cost.

Referring to FIG. 1, a prior art smoking system 30 for smoking food includes a smoke infusing component 32 having a battery and fan component 34 and a wood chip burning component 36. The smoke generating system 30 includes a flexible tube 38 having a proximal end 40 that is secured to the wood chip burning component 36 and a distal end 42 that is directed into an opening 44 formed in a glass dome 46. The wood chip burning component 36 has a burn chamber 48 that is adapted to receive wood chips or wood powder that are burned to generate smoke. The smoke is directed through the flexible tube 38 for being introduced through the opening 44 in the glass dome 46 for infusing smoke inside the glass dome. Food, such as meat, is placed inside the glass dome 46 for being infused with the smoke to generate smoke-infused meat.

FIG. 2 shows the battery and fan component 34 disassembled from the wood chip burning component 36. The battery and fan component 34 includes a fan 50 that forces the smoke from the wood chips burning in the combustion chamber to flow through the flexible tube 38 for being directed into the glass dome 46 (FIG. 1).

FIG. 3 shows a prior art smoke generating system utilized for infusing smoke into food and/or beverages. The smoke generating system 60 includes a base 62 having a fan incorporated therein that is able to direct smoke through a flexible tube 64 for being dispensed from a nozzle 66 attached to the distal end of the flexible tube 64.

Referring to FIGS. 3 and 4, the prior art smoke generating system 60 includes a combustion chamber 68 that is configured to receive wood chips 70 that may be burned for generating smoke. The base 62 has a fan that generates a high pressure air flow that forces the smoke that is generated within the combustion chamber 68 to flow into the proximal end of the flexible tube 64. The smoke flows to the distal end of the flexible tube 64, whereupon the smoke may be dispensed via the nozzle 66 located at the distal end of the flexible tube 64.

The prior art system shown in FIGS. 1-4 utilize relatively bulky components having external fans and burn chambers, whereby the smoke is directed into food and beverages through flexible tubes. The systems shown in FIGS. 1-4 comprise external components that must be coupled with additional equipment for infusing smoke into food and/or beverages.

In spite of the above advances, there remains a need for improved systems, devices and methods for infusing smoke into beverages such as cocktails. There also remains a need for efficient, economical, mobile, and simplified systems, devices and methods for infusing smoke into beverages.

In addition, there remains a need for smoke infusing systems that are smaller in size and that are able to integrate fans in a more efficient manner for minimizing the overall size of the systems and devices.

### SUMMARY OF THE INVENTION

In one embodiment, a cocktail smoking chimney for infusing smoke into a beverage includes a sealing base having a top major surface and a bottom major surface, and a smoke transfer opening located at the bottom major surface of the sealing base.

The cocktail smoking chimney preferably includes a chimney stack having an upper end, a lower end, and a central opening extending from the upper end to the lower end of the chimney stack, whereby the central opening of the chimney stack is in fluid communication with the smoke transfer opening formed in the bottom major surface of the sealing base;

In one embodiment, a porous screen is disposed inside the central opening of the chimney stack, adjacent the upper end of the chimney stack that is configured for holding wood chips or wood powder that are burned for generating smoke;

In one embodiment, a cocktail smoking chimney for infusing smoke into a beverage preferably includes a source of positive air pressure (e.g., a fan) in fluid communication with the central opening of the chimney stack for creating a vacuum within the central opening, which draws the smoke from the porous screen and forces the smoke to flow toward the lower end of the chimney stack and toward the smoke transfer opening formed in the bottom major surface of the sealing base.

In one embodiment, the fan for generating positive air pressure may be placed within the central opening of the chimney stack.

In one embodiment, a centrally located fan is positioned within the central opening of the chimney stack. The fan is coupled to a motor that is placed inside an enclosure that protects the motor from contaminants disposed within the smoke that may gum up and/or reduce the efficiency of the motor.

In one embodiment, the fan may be isolated from the central opening of the chimney stack and airflow pathways may be used for directing positive air pressure from the fan to flow into the central opening of the chimney stack.

In one embodiment, a cocktail smoking chimney for infusing smoke into a beverage (e.g., a cocktail) preferably includes a sealing base having a top major surface and a bottom major surface, a chimney stack projecting from the top major surface of the sealing base, and a combustion chamber disposed within the chimney stack. In one embodiment, the cocktail smoking chimney may include a screen (e.g., a porous) that holds wood chips or wood powder within the combustion chamber.

In one embodiment, the sealing base has a center, and the chimney stack is aligned with the center of the sealing base.

In one embodiment, the sealing base has a central region having a first thickness and an outer perimeter having a second thickness that is less (i.e., thinner) than the first thickness.

In one embodiment, the top and bottom major surfaces of the sealing base preferably taper inwardly toward one another between the central region and the outer perimeter thereof.

In one embodiment, the sealing base may have a disc or circle shape.

In one embodiment, a screen may be disposed within the combustion chamber of the chimney stack. In one embodiment, a combustible material may be disposed within the combustion chamber of the chimney stack. The screen may support the combustible material.

In one embodiment, the combustible material may be wood chips, wood powder and/or spices.

In one embodiment, the wood chips and the wood powder may be made of one or more of the following types of wood: apple, hickory, pecan, maple, cherry, and oak. In one embodiment, the wood chips and wood powder may include barrel-aged wood or mesquite infused wood.

In one embodiment, the spices placed into the combustion chamber may include cinnamon, rosemary and/or chai.

In one embodiment, a cocktail smoking chimney for infusing smoke into a beverage desirably includes a sealing base having a central region, an outer perimeter, a top major surface that extends between the central region and the outer perimeter, and a bottom major surface that extends between the central region and the outer perimeter.

In one embodiment, a chimney stack is preferably aligned with the central region of the sealing base and projects above the top major surface of the sealing base. In one embodiment, a combustion chamber is preferably disposed within the chimney stack.

In one embodiment, the cocktail smoking chimney preferably has one or more smoke transfer openings formed in the sealing base. In one embodiment, each smoke transfer opening desirably has an upper end in fluid communication with the combustion chamber and a lower end that is surrounded by a smoke directing lip.

In one embodiment, the central region of the sealing base preferably has a first thickness, and the outer perimeter of the sealing base preferably has a second thickness that is less than the first thickness.

In one embodiment, the top and bottom major surfaces of the sealing base preferably taper inwardly toward one another between the central region of the sealing base and the outer perimeter of the sealing base.

In one embodiment, the bottom major surface of the sealing base is tapered so that when the sealing base is placed over an open upper end of a drinking glass, the sealing base will self-center on the rim of the drinking glass to ensure that smoke directed into the enclosed space between the underside of the sealing base and a top surface of a beverage poured into the drinking glass will remain within the enclosed space for infusing into the beverage and so that the smoke cannot escape via the outer perimeter of the sealing base.

In one embodiment, the sealing base preferably has a larger outer diameter than the size of the opening at the open, upper end of the drinking glass to ensure the formation of an effective seal between the underside of the sealing base and the rim of the drinking glass.

In one embodiment, a method of infusing smoke into a beverage may include pouring a beverage into a drinking glass, and placing a cocktail smoking chimney over a rim at an open upper end of the drinking glass to define a sealed space inside the drinking glass that is located between an underside of the cocktail smoking chimney and a top surface of the beverage.

In one embodiment, the cocktail smoking chimney preferably includes a sealing base having a top major surface that faces away from the drinking glass and a bottom major surface that is in contact with the rim at the open upper end of the drinking glass, a chimney stack projecting from the top major surface of the sealing base, a combustion chamber disposed within the chimney stack, and one or more smoke transfer openings formed in the sealing base that extend from the combustion chamber to an underside of the sealing base.

In one embodiment, the method may include directing a flame into the combustion chamber for burning the wood inside the combustion chamber to generate smoke that passes through the one or more smoke transfer openings and into the sealed space between the bottom major surface of the sealing base and the top major surface of the beverage.

In one embodiment, prior to directing the flame into the combustion chamber, a combustible material (e.g., wood chips) may be placed inside the combustion chamber.

These and other preferred embodiments of the present patent application will be described in more detail herein.

### BRIEF DESCRIPTION OF THE DRAWINGS

FIG. 1 is a perspective view of a prior art system for smoking food.

FIG. 2 is a perspective view of smoke generating and fan components of the prior art system shown in FIG. 1.

FIG. 3 is a side view of a prior art system for generating smoke that is infused into food and beverages.

FIG. 4 is a perspective view of an upper end of the prior art system shown in FIG. 3.

FIG. 5 is a perspective view of a cocktail smoking chimney having an integrated fan, in accordance with one embodiment of the present patent application.

FIG. 6A is a side elevation view of the cocktail smoking chimney shown in FIG. 5.

FIG. 6B is a top view of the cocktail smoking chimney shown in FIG. 6A.

FIG. 7 is a cross-sectional view of a cocktail smoking chimney having an integrated fan, in accordance with one embodiment of the present patent application.

FIG. 8A is a perspective view of a cocktail smoking chimney having an integrated fan, in accordance with one embodiment of the present patent application.

FIG. 8B is a side elevation view of the cocktail smoking chimney shown in FIG. 8A.

FIG. 9A is an exploded view of the cocktail smoking chimney shown in FIGS. 8A and 8B.

FIG. 9B is another exploded view of the cocktail smoking chimney shown in FIGS. 8A and 8B.

FIG. 10A is a perspective view of a base of the cocktail smoking chimney shown in FIGS. 8A-8B and 9A-9B.

FIG. 10B is another perspective view of the base shown in FIG. 10A.

FIG. 11A is a perspective view of the base shown in FIGS. 10A and 10B with airflow restricting components inserted into a fan chamber and with an air direction cap inserted into an upper end of a chimney stack, in accordance with one embodiment of the present patent application.

FIG. 11B shows a top view of the base, the airflow restricting components inserted into the fan chamber, and the air direction cap shown in FIG. 11A.

FIG. 12 is a perspective view of the base shown in FIGS. 11A and 11B with a fan disposed within the fan chamber, in accordance with one embodiment of the present patent application.

FIG. 13 is a partial cross-sectional view of the cocktail smoking chimney shown in FIG. 11A with the air direction cap covering an upper end of a chimney stack, in accordance with one embodiment of the present patent application.

FIG. 14 is a cross-sectional view of the cocktail smoking chimney shown in FIGS. 8A and 8B.

FIG. 15A is a top view of a cocktail smoking chimney having an integrated fan, in accordance with one embodiment of the present patent application.

FIG. 15B is a perspective view of the cocktail smoking chimney with the integrated fan shown in FIG. 15A.

FIG. 16 is a top view of a base and the integrated fan of the cocktail smoking chimney shown in FIGS. 15A and 15B.

FIG. 17A is an exploded view of the cocktail smoking chimney shown in FIGS. 15A and 15B.

FIG. 17B is another exploded view of the cocktail smoking chimney shown in FIGS. 15A and 15B.

FIG. 18 is a cross-sectional view of the cocktail smoking chimney shown in FIGS. 15A and 15B.

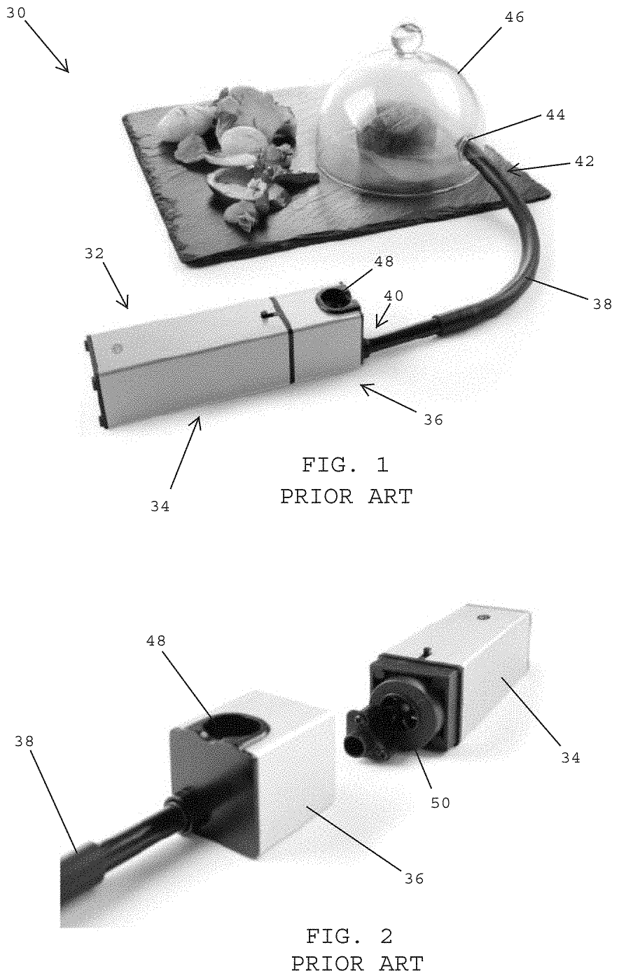

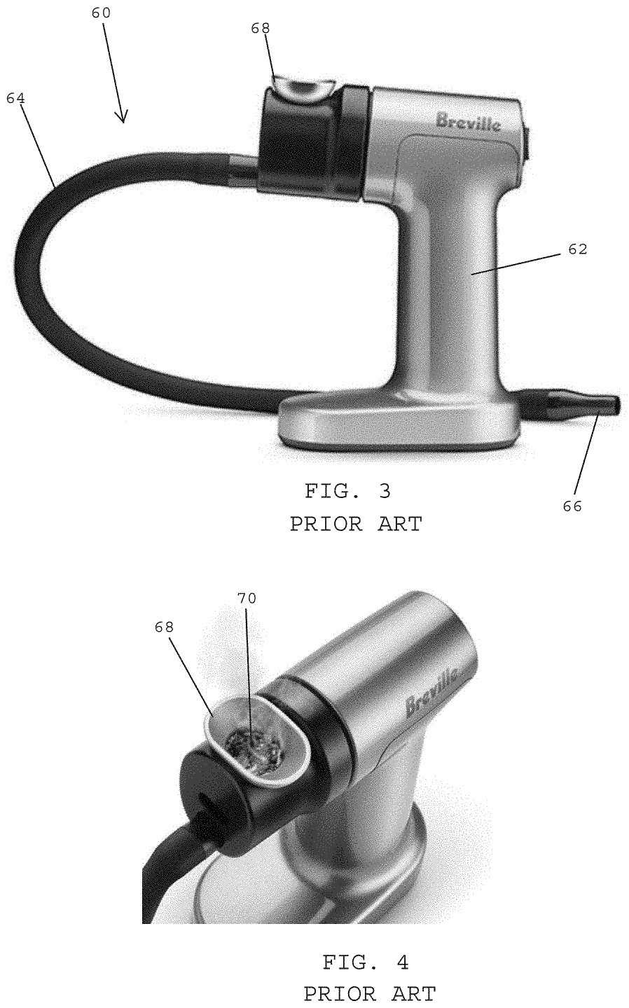

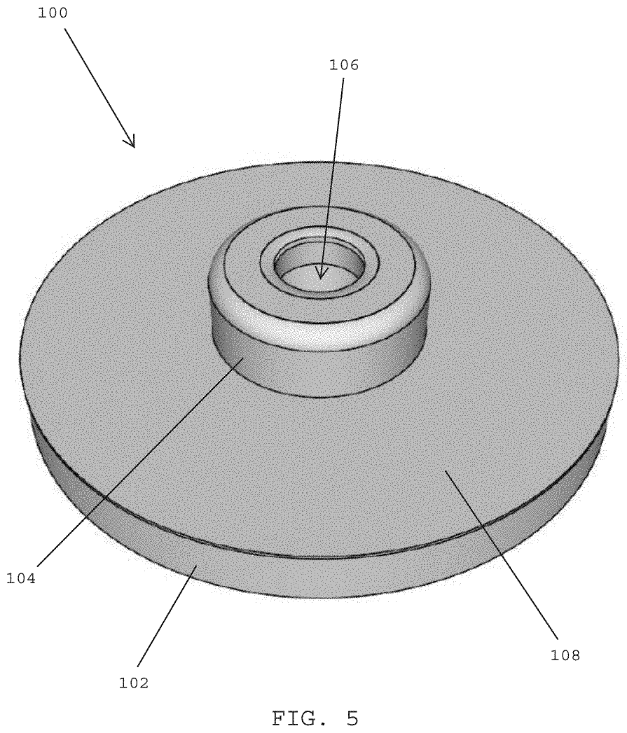

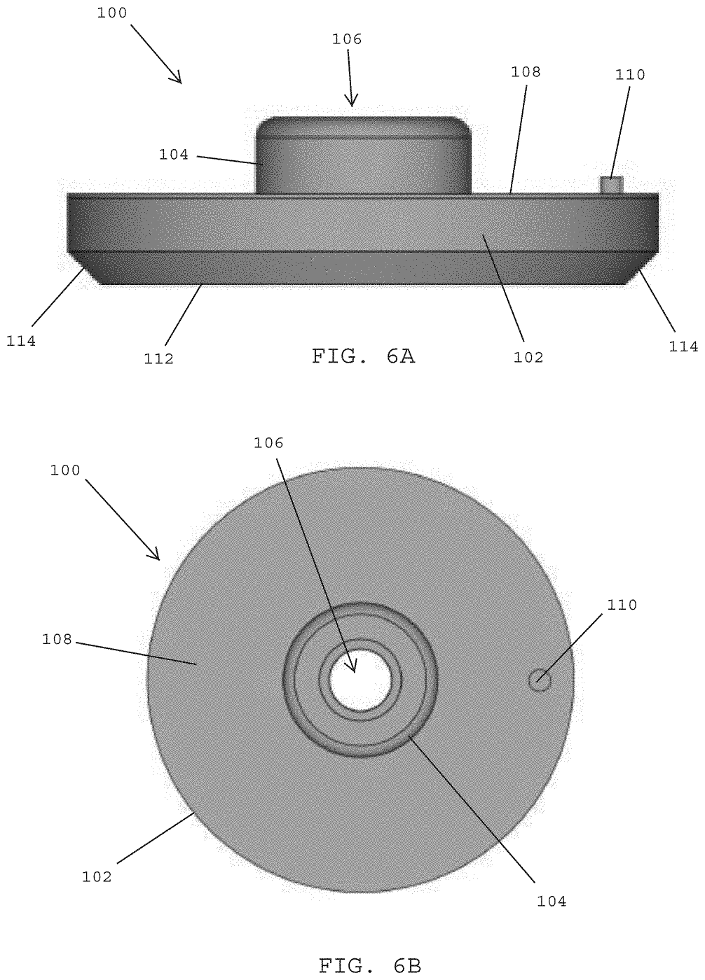

### DETAILED DESCRIPTION OF PREFERRED EMBODIMENTS

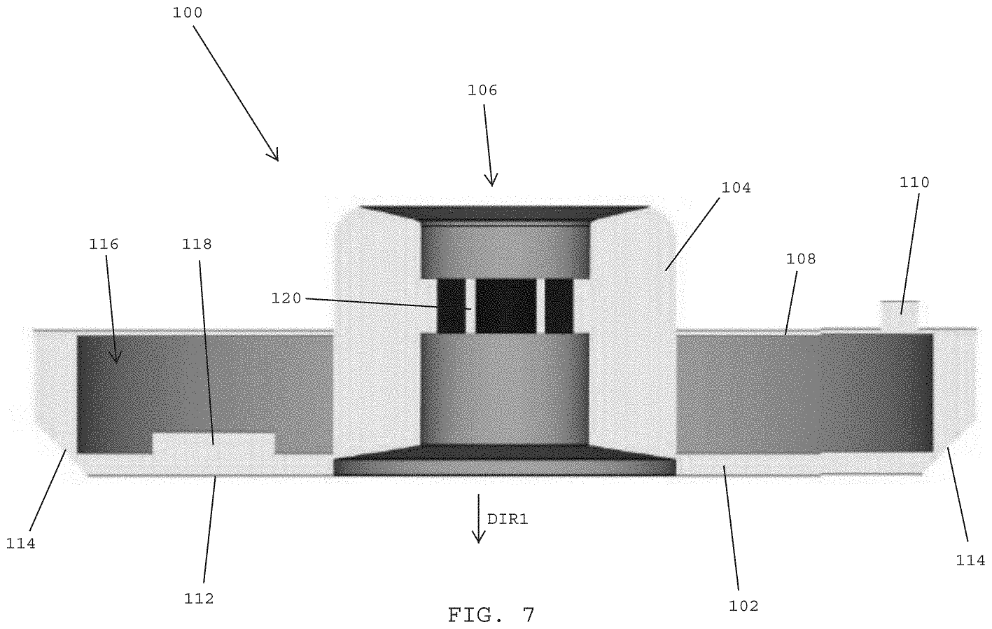

Referring to FIG. 5, in one embodiment, a cocktail smoking chimney 100 preferably includes a base 102 that is configured to be positioned over an open, upper end of a beverage container, such as a cocktail glass. The base preferably formed a seal with the upper end of the beverage container so that the smoke generated by the cocktail smoking chimney is efficiently directed into the upper end of the beverage container for infusing smoke into the beverage (e.g., a cocktail). The cocktail smoking chimney 100 preferably includes a chimney stack 104 having an upper end that surrounds a combustion chamber 106, which is adapted to receive wood chips and/or wood powder that may be burned for generating smoke that is infused into a beverage disposed within the beverage container.

In one embodiment, the cocktail smoking chimney 100 preferably includes a lid 108 that is configured to be secured atop the base 102. The cocktail smoking chimney 100 may include one or more compartments disposed between the lid 108 and the base 102 that are configured for receiving a battery, a motor, and/or a fan (not shown). In one embodiment, the fan may be operated for generating a vacuum and/or a downward airflow through the center of the chimney stack 104 for forcing the smoke generated within the combustion chamber 106 to flow from the bottom of the base 102 for infusing the smoke into a beverage/beverage container located under the cocktail smoking chimney 100.

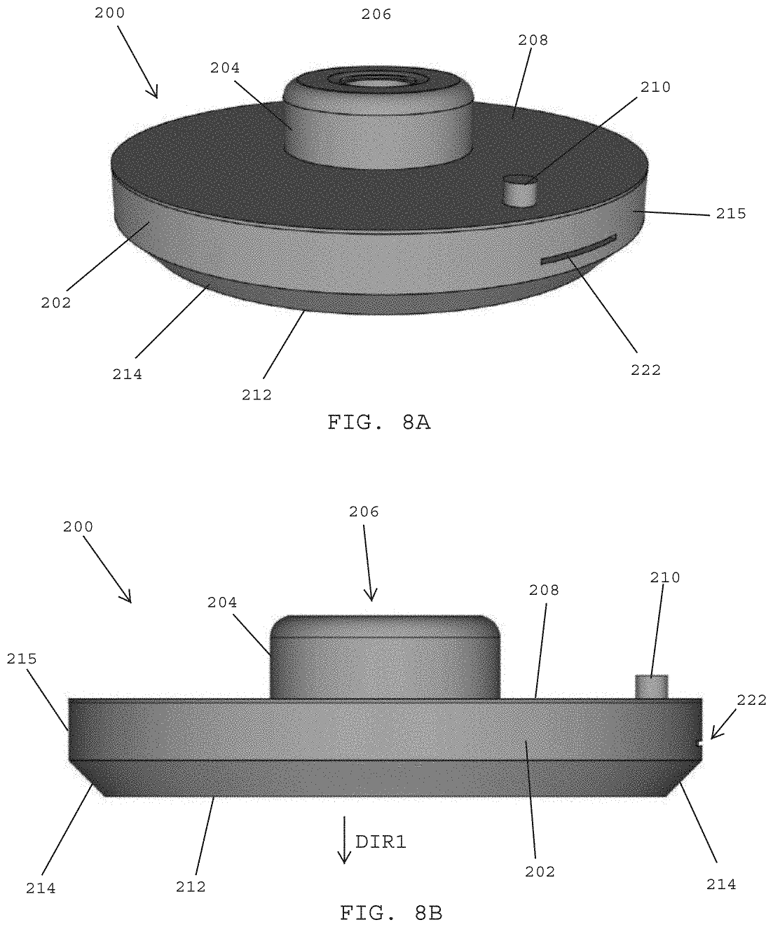

Referring to FIGS. 6A and 6B, in one embodiment, the cocktail smoking chimney 100 preferably includes the base 102 and the lid 108 secured atop the base. The chimney stack 104 projects above a top surface of the lid 102. The chimney stack 104 may be connected to the base and the lid may have an opening through which the chimney stack passes. In another embodiment, the chimney stack may be integrally formed with the lid.

In one embodiment, the lid 108 is snap fit onto the base 102 and forms an airtight seal therewith.

In one embodiment, the cocktail smoking chimney 100 preferably includes an on/off switch 110 that may be engaged for turning a fan on and off. In one embodiment, as will be described in more detail herein, the fan generates high pressure air that flows from an opening in the bottom surface 112 of the base for forcing the smoke generated within the combustion chamber 106 to flow in the downward direction designated DIR1 (FIG. 6A). The downwardly directed smoke is preferably directed into a beverage contained within a beverage container such as a cocktail glass.

Referring to FIG. 6A, in one embodiment, the outer periphery of the base 102 near the bottom surface 112 thereof defines a sloping surface 114 that is configured to conform to the open upper end of a beverage container (e.g., a cocktail glass) to ensure that the bottom of the base 102 forms a seal with the inner surface of the beverage container and/or the rim of the glass so that all of the smoke forced from the bottom surface 112 of the base 102 of the cocktail smoking chimney 100 is directed into the beverage that is contained within the beverage container.

In one embodiment, a power source for powering a fan, such as a battery, may be positioned within a compartment disposed between the base 102 and the lid 108. In one embodiment, the power source preferably provides power for operating a fan that is disposed within the chimney stack 104 of the cocktail smoking chimney 100. The fan preferably includes a motor that is coupled with the power source so that the motor operates to rotate the fan to generate the airflow pattern DIR1 from the bottom surface 112 of the base 102.

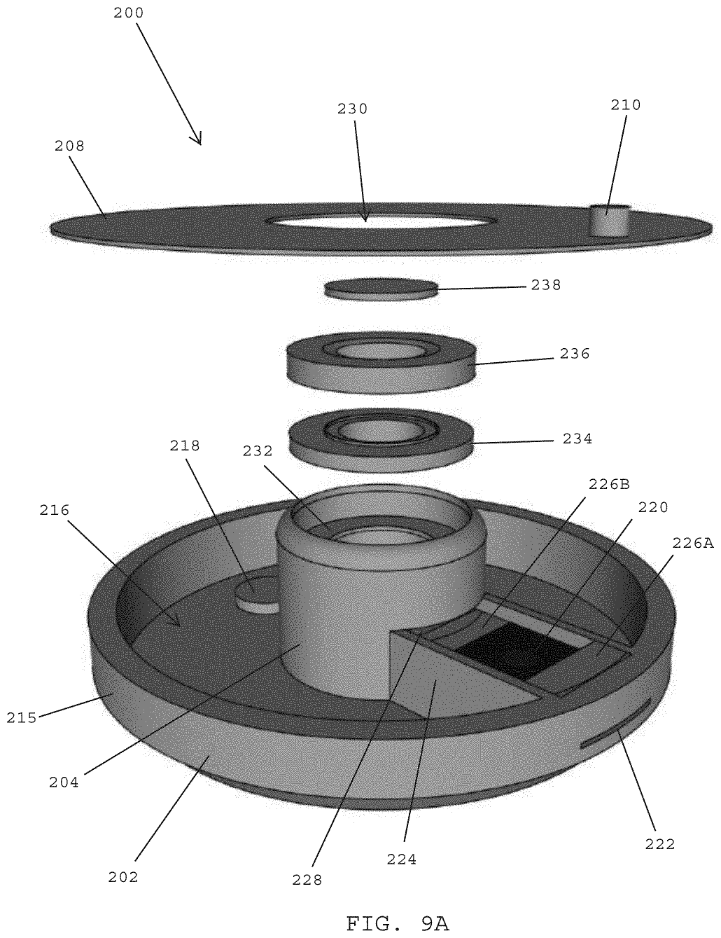

Referring to FIG. 7, in one embodiment, the cocktail smoking chimney 100 preferably includes the base 102 and the lid 108 that is secured atop the base. The cocktail smoking chimney 100 desirably includes a battery compartment 116 disposed between the lid 108 and the base 102, which is adapted to receive a battery 118 that powers a fan 120 that is incorporated into the chimney stack 104. In one embodiment, the on/off switch 110 may be engaged whereupon the battery 118 sends power to a motor coupled with the fan 120 for generating a vacuum at the combustion chamber 106 located at the upper end of the chimney stack 104. The fan 120 desirably directs the smoke generated by burning the wood chips and/or wood powder to flow in the direction DIR1 from the bottom of the chimney stack 104. The bottom surface 112 of the base 102 preferably overlies a rim or upper end of a beverage container. In one embodiment, the sloping surfaces 114 at the outer perimeter of the base 102 form a seal with an inner surface of the beverage container to form a seal between the base and the rim of the beverage container. The smoke is preferably directed from the bottom surface of the base 102 and into the beverage for infusing the beverage with the smoke.

In one embodiment, after a beverage has been infused with smoke, the on/off switch 110 may be engaged (e.g., moved into the off position) for stopping the fan 120, which will no longer generate a vacuum within the chimney stack 104.

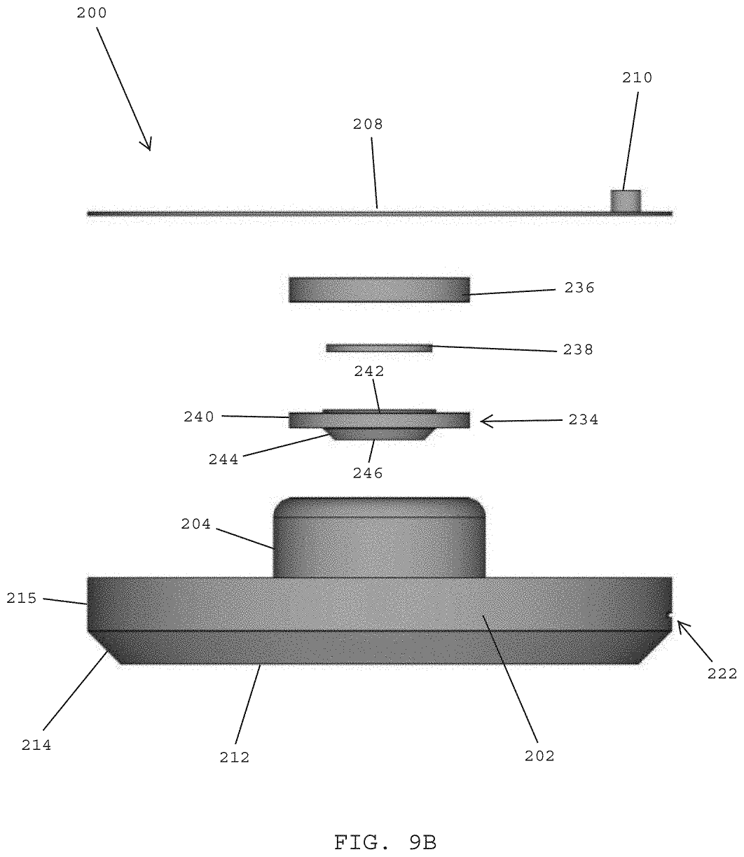

Referring to FIGS. 8A and 8B, in one embodiment, a cocktail smoking chimney 200 having an integrated fan preferably includes a base 202 and a chimney stack 204 projecting upwardly from the base. The chimney stack 204 preferably has a combustion chamber 206 and an upper end thereof that is adapted to receive wood chips that may be burned for generating smoke that is infused from the bottom 214 of the base 202. In one embodiment, a screen that holds the wood chips is preferably positioned at the upper end of the chimney stack.

In one embodiment, the cocktail smoking chimney 200 desirably includes a lid 208 that is secured over an upper end of the base 202. The cocktail smoking chimney 200 desirably includes an on/off switch 210 that may be engaged for activating a fan (not shown), as will be described in more detail herein. The on/off switch may be located at various locations over the outer surface of the cocktail smoking chimney. In one embodiment, the base 202 has a sidewall 215 that extends around the outer perimeter of the base and a sloping surface 214 that slopes inwardly between the sidewall 215 and the bottom surface 212 of the base 202.

In one embodiment, the sloping surface is configured for engaging a sloping inner surface of a beverage container (e.g., a cocktail glass) for forming a seal between the base of the cocktail smoking chimney and the upper end of the beverage container.

In one embodiment, the cocktail smoking chimney 100 preferably includes an ambient air slot 22 that is formed in the peripheral sidewall 215 of the base 202 for enabling ambient air (e.g., external air) to be drawn into a fan compartment of the cocktail smoking chimney 200 as will be described in more detail herein.

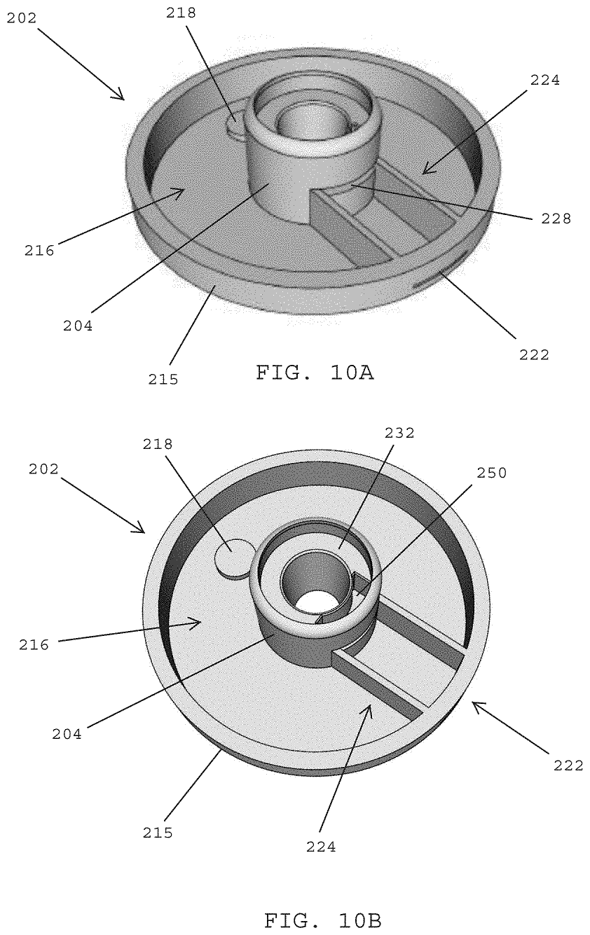

Referring to FIGS. 9A and 9B, in one embodiment, the cocktail smoking chimney 200 preferably includes the base 202 having a peripheral sidewall 215 that extends around an outer perimeter of the base. The base 202 has an open upper end defining one or more chambers therein that are adapted to receive components of the cocktail smoking chimney. In one embodiment, the base 202 preferably includes a first compartment 216 formed therein that is adapted to receive a power source 218 (e.g., a battery) that is configured to power a fan 220 that is disposed within a fan compartment 224 formed in the base 202. In one embodiment, the fan compartment 224 is adapted to receive the fan 220 and is bounded by airflow restrictors 226A, 226B that are disposed on opposite sides of the fan 220 for constricting and/or defining the airflow pathway between the ambient air slot 222 and an interior air slot 228 formed in a sidewall of the chimney stack 204.

Smoke that is generated from burning wood chips and wood powder can damage fans and motors, particularly after long periods of exposure. The smoke contains contaminants and/or particles (e.g., oil) that may gum up the components of the fan and/or motor. Although the present patent application is not limited by any particular theory of operation, it is believed that positioning the fan and/or the motor outside of the chimney stack 204 and outside of the flow of the smoke generated in a combustion chamber of the cocktail smoking chimney will isolate the fan and/or the motor, and minimize the exposure of these components to the smoke.

In one embodiment, the cocktail smoking chimney 200 preferably includes the lid 208 that is adapted to be secured over the open upper end of the base 202. In one embodiment, the lid 208 may include the on/off switch 210 that may be engaged for activating the fan 220 disposed within the fan chamber 224. In one embodiment, the lid 208 may include a central opening 230 that is adapted to receive the chimney stack 204 when the lid 208 is assembled with the base 202.

In one embodiment, the upper end of the chimney stack 204 preferably includes an annular ledge 232 that extends around a central opening that extends from the upper end and the lower end of the chimney stack 204. The central opening preferably extends to the bottom surface of the base 202 for directing the smoke to flow from the bottom of the cocktail smoking chimney.

In one embodiment, the cocktail smoking chimney 200 desirably includes an airflow direction cap 234 that is seated atop the ledge 232, a screen holder 236 that is positioned atop the airflow direction cap 234, and a screen 238 that is positioned atop the screen holder 236. In one embodiment, wood chips and/or wood powder may be disposed atop the screen 238. The wood powder and/or wood chips may be burned for generating smoke, which flows through the central opening of the chimney stack 204 and from the bottom surface 212 of the base 202.

Referring to FIG. 9B, in one embodiment, the base 202 has a sloping surface 214 that extends between the peripheral sidewall 215 and the bottom surface 212 of the base 202. The sloping surface 214 is preferably configured for abutting against an interior sloping surface of a beverage container (e.g., a cocktail glass) for forming a seal between the bottom of the base 202 and the rim of the beverage container so that the smoke generated by the cocktail smoking chimney is infused into a beverage (e.g., a cocktail) contained within the beverage container.

In one embodiment, the airflow direction cap 234 preferably includes a ring section 240 that is adapted to be disposed within the opening at the upper end of the chimney stack 204. In one embodiment, the outer perimeter of the ring section 240 preferably forms a seal with an inner surface of the upper end of the chimney stack 204. In one embodiment, the airflow direction cap 234 preferably includes a funnel-shaped structure 242 having an inwardly sloping bottom surface 244 that slopes inwardly toward a bottom surface 246 thereof. As will be described in more detail herein, the sloping surface 244 of the funnel-shaped component 242 is preferably adapted to direct the high pressure air created by the fan in the fan chamber to flow into the central opening of the cocktail chimney 204, which, in turn creates a vacuum under the screen 238 that is configured to contain wood chips and/or wood powder. The vacuum preferably draws the smoke from the burning wood chips and forces the smoke the flow downwardly through the central opening of the chimney stack 204 for being directed through an opening at the bottom surface 212 of the base 202.

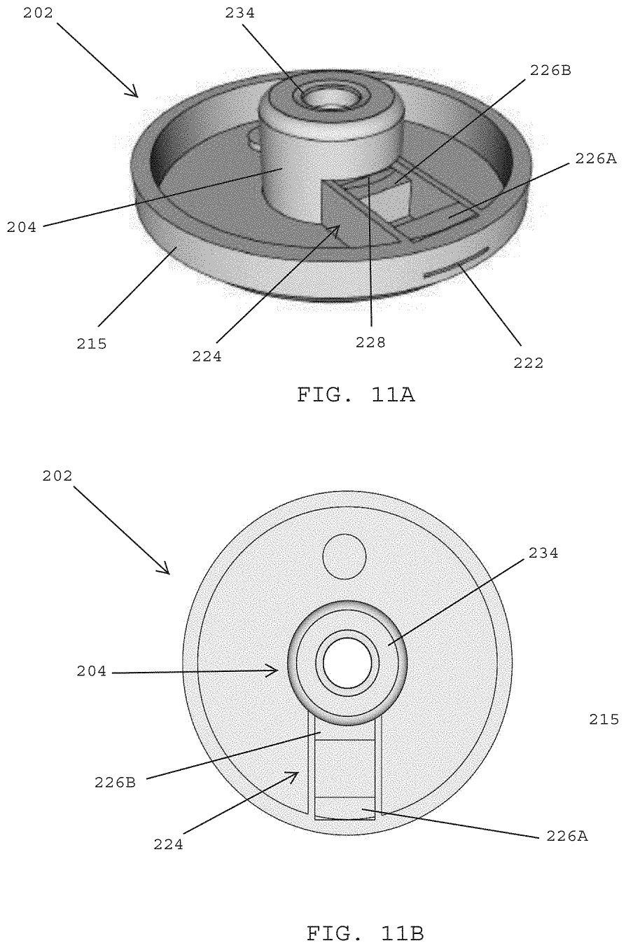

Referring to FIGS. 10A and 10B, in one embodiment, the base 202 preferably has the peripheral sidewall 215 that extends around an outer perimeter of the base. The sidewall 215 has an upper end that defines an open upper end of the base 202 that contains a battery compartment 216 for the battery 218 and a fan chamber 224 for the fan 220 (FIG. 9A).

In one embodiment, the base 202 includes the ambient air slot 222 that is formed in the peripheral sidewall 215 of the base. The ambient air slot 222 enables ambient air to be drawn into the outer end of the fan chamber 224 that contains the fan 220 (FIG. 9A). In one embodiment, the base 202 preferably includes the interior air slot 228 located at an inner end of the fan chamber 224 that enables the air flowing through the fan chamber 224 to be directed into an interior airflow chamber 250 disposed inside the chimney stack 204.

In one embodiment, the air directed into the interior airflow chamber 250 preferably circulates in a concentric pattern about the ledge 232 disposed adjacent an upper end of the chimney stack 204. The ledge 232 is preferably configured to circulate the air about the central opening 205 of the chimney stack 204. As the air flow circulates about the ledge 232, the airflow direction cap 234 (FIGS. 9A and 9B), and particularly the sloping surface 244 of the airflow direction cap, directs the air to flow through the central opening 205 and toward the lower end of the chimney stack 204.

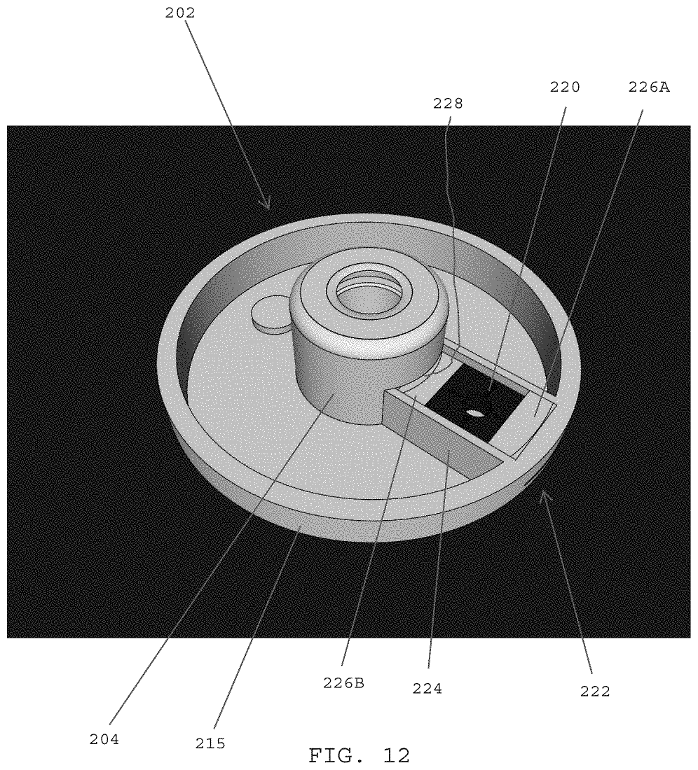

Referring to FIGS. 11A and 11B, in one embodiment, the first and second airflow restrictors 226A, 226B may be disposed at the outer and inner ends of the fan chamber 224. In one embodiment, the first airflow restrictor 226A is disposed adjacent the ambient air slot 222 formed in the peripheral sidewall 215 of the base 202. In one embodiment, the second airflow restrictor 226B is disposed adjacent the inlet air slot 228 located at the distal end of the fan chamber 224.

In one embodiment, the first airflow restrictor 226A may have an outer surface that conforms to the curvature of an interior surface of the peripheral sidewall 215 of the base 202. In one embodiment, the second airflow restrictor 226B may have an inner surface that conforms to the shape of the outer wall of the chimney stack 204.

The airflow restrictors preferably define a relatively restricted airflow pathway between the ambient air slot 222 and the inner air slot 228.

In one embodiment, the airflow direction cap 234 may be inserted into the open upper end of the chimney stack 204.

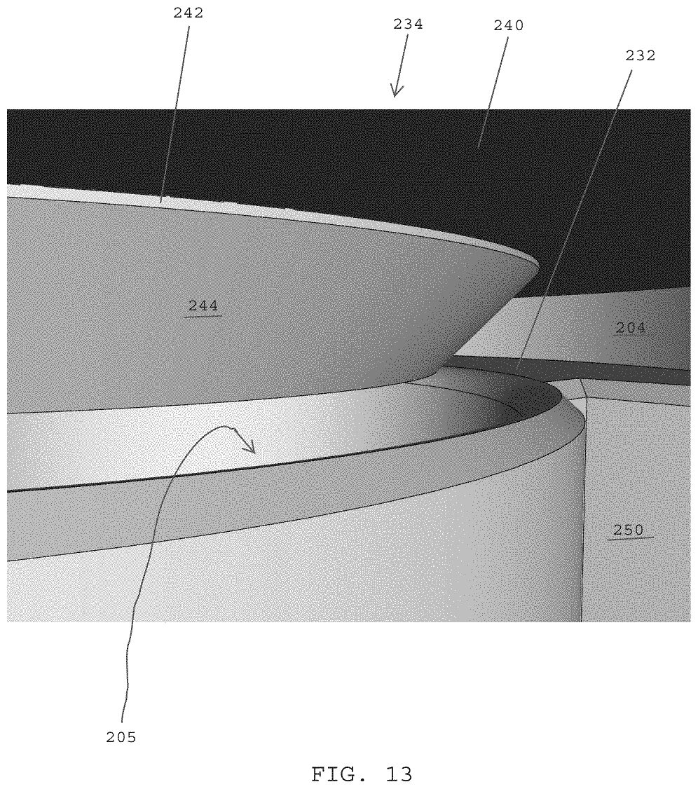

Referring to FIG. 12, in one embodiment, the fan 220 may be inserted into the fan compartment 224. The fan 220 is preferably disposed between the first airflow restrictor 226A positioned at the proximal end of the fan chamber 224 and adjacent the ambient air slot 222 formed in the peripheral sidewall 215 of the base 202. The distal end of the fan 220 is preferably bounded by the second airflow restrictor 226B that is positioned adjacent the inner air slot 228 formed in the outer wall of the chimney stack 204.

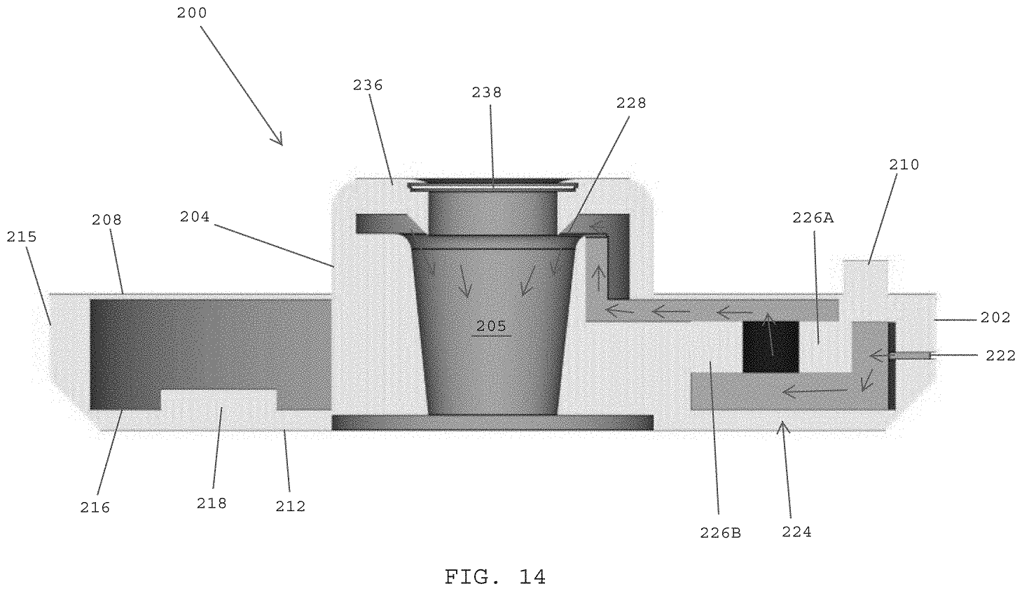

Referring to FIG. 13, in one embodiment, the airflow direction cap 234 is preferably secured over the upper end of the chimney stack 204. The ring 240 of the airflow direction cap 234 preferably forms a seal with the upper end of the chimney stack 204. The funnel-shaped component 242 of the airflow direction cap 234 is desirably positioned over the central opening 205 of the chimney stack 204. The sloping surface 244 of the funnel-shaped component 242 is also positioned over the central opening 205 and the chimney stack 204. WNhen the high pressure air generated by the fan is directed into the interior airflow chamber 250, the high pressure air desirably flows in a concentric pattern around the ledge 232 that is adjacent the upper end of the chimney stack 204. The concentrically flowing air is directed by the sloping surface 244 into the central opening 205 of the chimney stack 204, which generates a vacuum within the central opening 205 for directing the smoke generated within the combustion chamber to flow toward the lower end of the chimney stack 204.

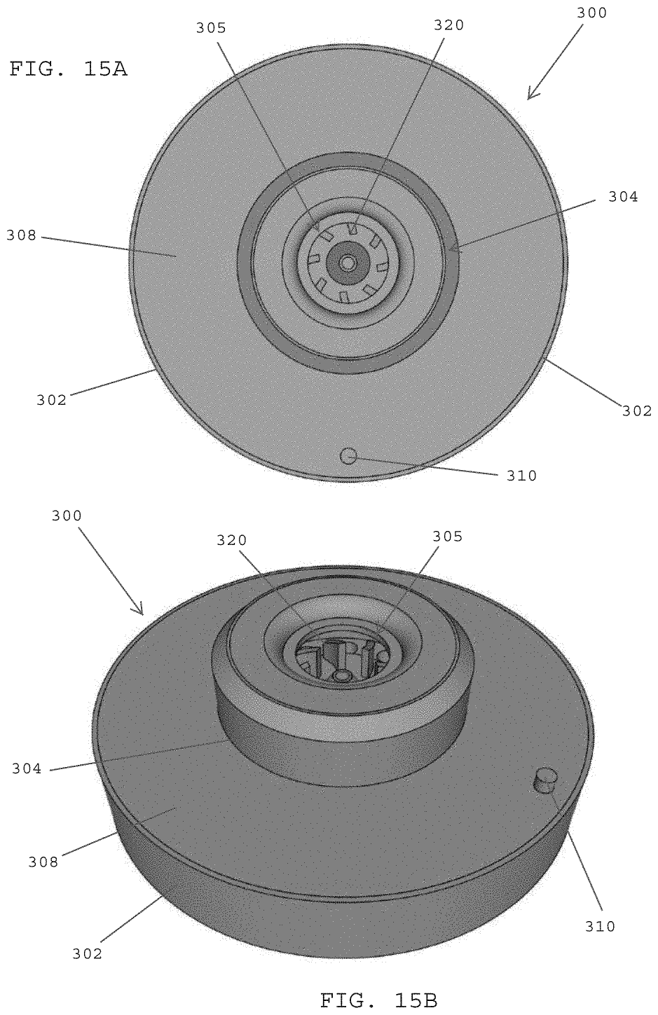

Referring to FIG. 14, in one embodiment, the cocktail smoking chimney 200 shown and described above in FIGS. 8A-13 preferably includes the base 202 and the lid 208 secured atop the base 202. The chimney stack 204 projects upwardly from the base 202 and passes through a central opening formed in the lid 208.

The cocktail smoking chimney 202 preferably includes the fan compartment 224 that contains the fan 220 that is bounded by the first and second airflow restrictors 226A, 226B. The ambient air inlet slot 222 is formed in the peripheral sidewall 215 of the base 202. The cocktail smoking chimney 200 preferably includes the battery compartment 216 that contains the battery 218 that powers the fan 220.

The first and second airflow restrictors 226A, 226B preferably define an airflow stream that extends between the ambient air slot 222 and the inner air slot 28 that is formed in the sidewall of the chimney stack 204. The airflow pattern generated by the fan is depicted by arrows in FIG. 14. The fan 220 creates an airflow stream under positive pressure that is directed by the airflow direction cap 234 to flow into the central opening 205 of the chimney stack 204. The airflow direction cap 234 is preferably secured over the upper end of the chimney stack 204. The screen holder 236 that contains the screen 238 is preferably secured over the airflow direction cap 234. In one embodiment, wood chips and/or wood powder may be placed on the screen 238 and burned to generate smoke. When the fan 220 is turned on, the fan creates the air flow pattern that generates a vacuum within the central opening 205 and the chimney stack 204. The vacuum draws smoke generated by the burning wood chips to flow through the central opening 205 for being expressed from the bottom surface 212 of the base 202.

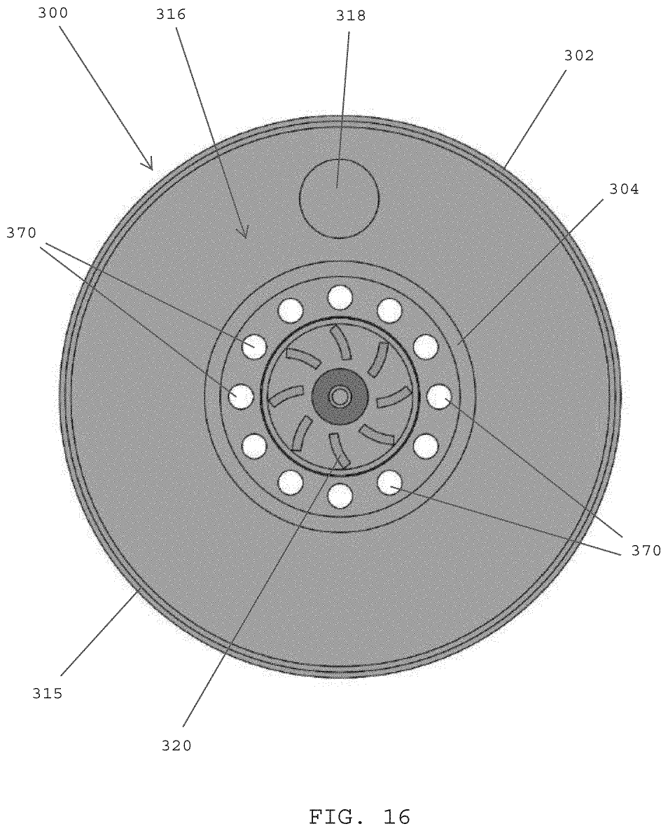

Referring to FIGS. 15A and 15B, in one embodiment, a cocktail smoking chimney 300 preferably includes a base 302, a chimney stack 304, a lid 308 secured atop an upper end of the base 302, and an on/off switch 310 that may be used for activating a fan 320 disposed within a central opening 305 of the chimney stack 304.

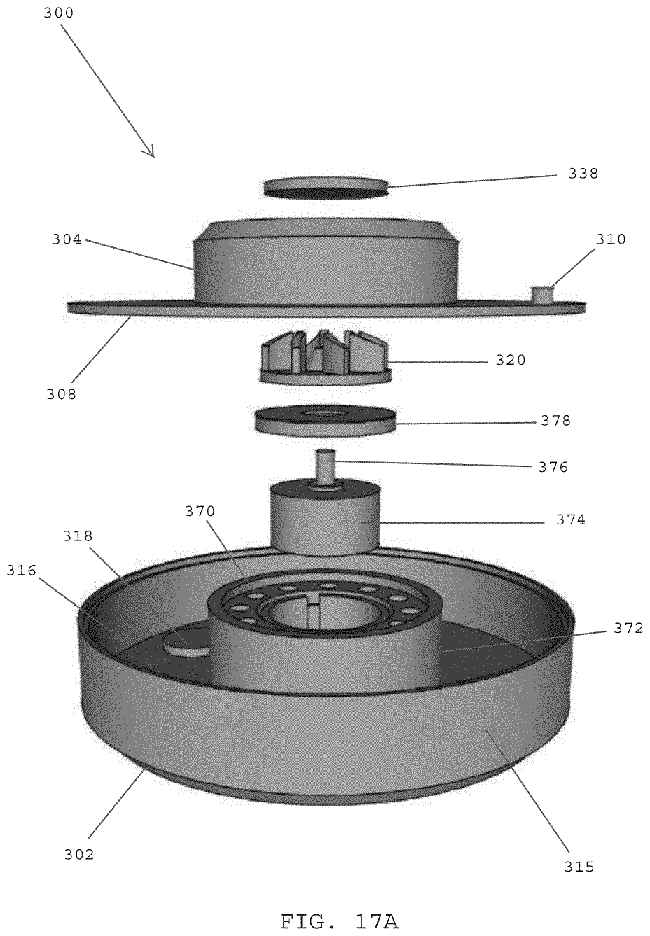

Referring to FIG. 16, in one embodiment, the base 302 has a peripheral sidewall 315 that extends around the outer perimeter of the cocktail smoking chimney 300. The base 302 has a battery compartment 316 that is adapted to receive a battery 318 that provides power for operating the centrally located fan 320. The chimney stack 304 preferably includes a plurality of airflow openings 370 that are spaced around the outer perimeter of the centrally located fan 320 and that extend to the bottom surface of the base 302. The airflow openings 370 are used for expressing smoke from the bottom surface of the base 302.

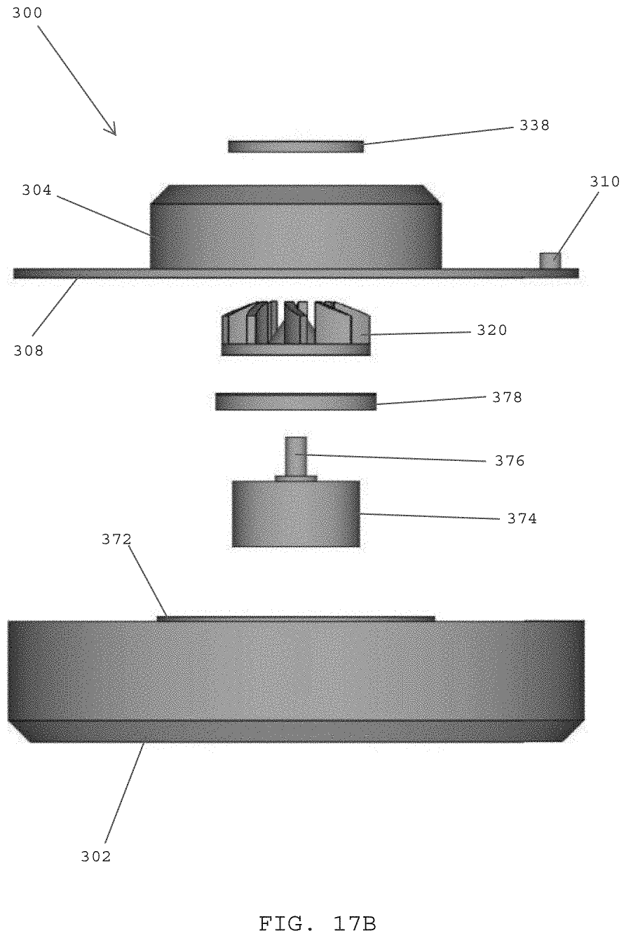

Referring to FIGS. 17A and 17B, in one embodiment, the base 302 preferably includes the battery compartment 316 that contains the battery 318. The base 302 has a motor housing 372 that is adapted to seat a motor 374 having a rotatable shaft 376. The airflow openings 370 for expressing smoke are preferably disposed about an outer perimeter of the motor housing 372. The airflow openings 370 preferably surround the motor 374, which is seated within the motor housing 372. The cocktail smoking chimney 300 preferably includes a sealing ring 378 that is adapted to be secured atop the motor 374. The rotatable shaft 376 extends through an opening in the sealing ring 378 for being coupled with an underside of the fan 320. The battery 318 preferably provides power to the motor 374 for rotating the rotatable shaft 376, which, in turn rotates the fan 320 for generating a vacuum within the central opening of the chimney stack 304.

The lid 308 including the chimney stack 304 is preferably secured over the upper end of the sidewall 315 of the base 302. The screen 338 adapted to receive the wood chips is positioned within the central opening of the chimney stack 304. The on/off switch 310 may be engaged for activating the motor 374 to rotate the fan 320 for generating a vacuum beneath the screen 338 to direct the smoke to flow through the openings 370 positioned around the motor 374 disposed within the motor housing 372.

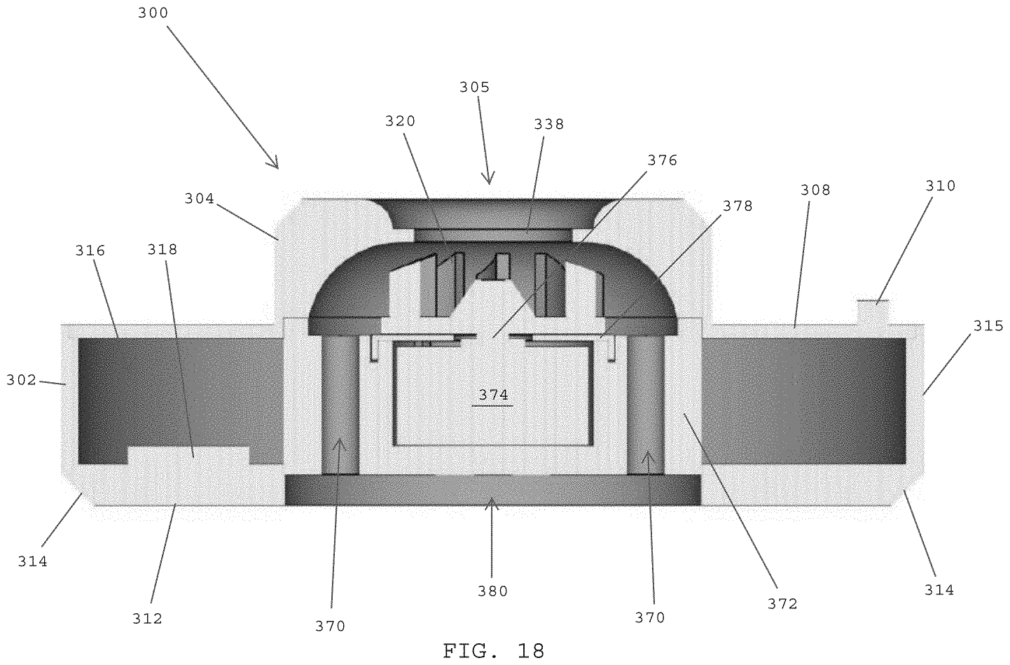

Referring to FIG. 18, in one embodiment, the cocktail smoking chimney 300 preferably includes the base 302 having the lid 308 secured to an upper end of the outer peripheral sidewall 315 of the base. The chimney stack 304 desirably projects upwardly from a top surface of the lid 308. The chimney stack 305 preferably defines a central opening 305 that is adapted to receive the screen 338 configured for combusting wood chips. The cocktail smoking chimney 300 desirably includes the centrally located fan 320 that is mounted atop a rotatable shaft 376 that projects from an upper end of the motor 374. The motor 374 is disposed within the motor housing 372 that has the elongated openings 370 extending therethrough for delivering smoke to the central opening 380 at the bottom surface 312 of the base 302.

In one embodiment, the cocktail smoking chimney 300 preferably includes a battery compartment 316 disposed between the lid 308 and the base 302 that is adapted to receive the battery 318.

The cocktail smoking chimney 300 preferably includes the sealing ring 378 that forms a snap-fit connection with the upper end of the motor housing 372 to protect the motor 374 from the contaminants present in the smoke that flows through the chimney stack 304 and the airflow openings 370.

In one embodiment, the on/off switch 310 may be engaged for activating the motor 374 to rotate the rotatable shaft 376, which, in turn rotates the centrally located fan 320. The centrally located fan 320 rotates about a central axis, which generates a vacuum beneath the screen 338 that contains the burning wood chips. The vacuum directs the smoke from the burning wood chips to flow through the elongated airflow openings 370 for being dispensed via the centrally located openings 380 at the bottom surface 312 of the base 302. The base 302 of the cocktail smoking chimney preferably sits atop a beverage container and the smoke is preferably infused into the beverage from the bottom surface 312 of the base 302.

In one embodiment, the bottom surface 320 and the sloping outer edge 314 is preferably positioned atop or inside a rim of a beverage container such as a cocktail glass. When the cocktail smoking chimney 300 is activated, the smoke created by burning the wood chips is directed through the elongated airflow openings 370 and into the beverage contained within the beverage container for creating a smoke-infused beverage.

While the foregoing is directed to embodiments of the present invention, other and further embodiments of the invention may be devised without departing from the basic scope thereof, which is only limited by the scope of the claims that follow. For example, the present invention contemplates that any of the features shown in any of the embodiments described herein, or incorporated by reference herein, may be incorporated with any of the features shown in any of the other embodiments described herein, or incorporated by reference herein, and still fall within the scope of the present invention.

What is claimed is:

1. A cocktail smoking chimney for infusing smoke into a beverage comprising:
a sealing base having a top major surface and a bottom major surface, and a smoke transfer opening located at said bottom major surface;
a chimney stack having an upper end, a lower end, and a central opening extending from said upper end to said lower end of said chimney stack, wherein said central opening of said chimney stack is in fluid communication with said smoke transfer opening formed in said bottom major surface of said sealing base;
a porous screen disposed inside said central opening of said chimney stack, adjacent said upper end of said chimney stack that is configured for holding wood chips or wood powder that are burned for generating smoke;
a source of positive air pressure in communication with said central opening of said chimney stack for creating a vacuum within said central opening that draws said smoke from said screen and forces said smoke to flow toward said lower end of said chimney stack and toward said smoke transfer opening formed in said bottom major surface of said sealing base.

2. The cocktail smoking chimney as claimed in claim 1, wherein said source of positive air pressure is a fan.

3. The cocktail smoking chimney as claimed in claim 1, further comprising:
a lid overlying said sealing base to define a battery compartment between said lid and said sealing base;
a battery disposed within said battery compartment that is coupled with said fan.

4. The cocktail smoking chimney as claimed in claim 3, further comprising a motor coupled with said battery and said fan, wherein said battery provides electrical energy for operating said motor and said motor is configured to rotate said fan.

5. The cocktail smoking chimney as claimed in claim 4, further comprising and on/off switch connected with said motor for turning said motor on and off.
